(19) United States
(12) Patent Application Publication
(10) Pub. No.: US 2006/0185486 A1
(43) Pub. Date: Aug. 24, 2006

(54) Powered saw apparatus

(76) Inventor: Robert Firth, Victoria (AU)

Correspondence Address: HEAD, JOHNSON & KACHIGIAN, 228 W 17TH PLACE, TULSA, OK, 74119, US

(21) Appl. No.: 11/353,700

(22) Filed: Feb. 14, 2006

(30) Foreign Application Priority Data
Feb. 15, 2005 (GB) 0503102.6

(51) Int. Cl. B23D 19/00; B26D 1/18

(52) U.S. Cl. 83/473; 83/581; 83/487

(57) ABSTRACT

The invention relates to a mitre, compound or chop saw apparatus which include a cutting head movable between raised and lowered positions. The cutting head is mounted on a slide so as to be movable therealong with respect to the base. The slide has at least one external elongate flat face which acts as a guide face for the movement of the cutting head therealong and overcomes the need for a plurality of slides to be provided.

The invention to which this application relates is powered saw apparatus of the type which includes a base and a cutting head housing a rotatable circular blade. The cutting head is movable between a raised position and a lowered cutting position for cutting a work piece mounted on the base. Saws of this type include chop saws, compound saws and mitre saws.

The cutting unit includes a base typically with a turntable which is rotatable with respect to the rest of the base. The top surfaces of the base and turntable form a surface onto which the workpiece to be cut is positioned. A fence or fences can be provided on the said surface to act as a vertical location for an edge of the workpiece. Towards the rear of the base is provided a mounting onto which the cutting head is located. The cutting head may be located in a fixed position with regard to the horizontal plane or may include one or a plurality of slide members and it is to this type of arrangement that the invention relates. The cutting head itself is typically pivotally movable at least between a raised and lowered position in a vertical plane and may also be angularly adjustable about a horizontal axis and about the vertical plane to allow mitre cuts to be performed. The same can also be provided with a bevel movement mechanism. Each or any of these mechanisms can be incorporated in the cutting unit as described in part of the invention, as the invention is principally concerned with the provision of the slide or guide members.

In use, the cutting unit is conventionally provided to be moved along said slide members by the user thereby allowing a distance of travel of the cutting unit with respect to the base in the horizontal plane. The slides are conventionally provided of round cross section and, as a result, require, at the very least, one slide and a further bearing along the slide but, more typically, at least two slide members to be provided to allow the accurate location of the cutting head in all axes and thereby provide the controlled sliding movement of the cutting head as it is important that the cost is straight, accurate and predictable with respect to the measurement scales on the apparatus.

The provision of the second and/or further slides, means that the expense of the manufacture of the cutting unit is increased and furthermore, the provision of slides of circular cross section typically requires that the same are ground and/or further machined so as to provide the required smoothness to allow the smooth movement of the cutting unit along the slides. The slides can be mounted above or pass into the base and/or turntable.

A further problem with the provision of the slide mechanisms in the conventional cutting unit is that because the slides are required to be positioned accurately, and the bearing assemblies which allow the cutting head to move along the slides, are relatively complex, the same are required to be factory assembled and set. This therefore means that the slide members are required to be provided as an integral part of the cutting unit at the time of manufacture. Because the slide members are required to allow a length of travel, beyond the base size, the slides protrude beyond the rear of the base which therefore means that the size of packaging required to accommodate the cutting unit is relatively large and a significant portion of this size is to accommodate the slide rather than any other part of the cutting unit.

The aim of the present invention is to provide a cutting unit of an improved form which allows performance of the cutting unit to be maintained while, at the same time, allowing a reduction in the materials used. A further aim is to provide a reduction in the packaging which is required for transport of the cutting unit.

In a first aspect of the invention there is provided a cutting unit including a cutting head having a circular blade provided for rotation thereon, said cutting head pivotally movable between a raised position and a lowered, cutting, position, said cutting head located on a mounting connected to a base on which the workpiece to be cut can be located, said cutting head slidingly movable with respect to the base via at least one slide and wherein said slide is provided, in at least the portion where sliding movement occurs, with at least one elongate, substantially flat, outer face.

In one embodiment, a plurality of the external elongate faces of the slide has a flat profile and the slide in cross section is of a geometric shape, such as, for example, substantially square in cross section, substantially hexagonal in cross section, substantially triangular in cross section or alternatively can be formed of an angled section.

In one embodiment, only one slide is required to be provided as the external faces of the same provide the required location of the cutting head in all axes apart from the longitudinal axis of the slide, when stationary and when moving. In an alternative embodiment, a plurality of slide members are provided.

Typically, the slide is mounted in conjunction with a bearing system, said system having a configuration to allow substantially smooth movement. Typically, the bearing assembly is of a length so as to provide the required degree of support so as to maintain the longitudinal axis of the slide in a substantially horizontal plane regardless of the particular position of the slide with the bearing assembly.

In one embodiment, the bearing assembly is provided as part of the base mounting and the slide and cutting head attached at one end is movable with respect to the bearing assembly. In an alternative embodiment the slide is fixed at one end to the base mounting and the bearing assembly is provided on the cutting head and is movable with the cutting head along the slide.

In one embodiment, a pivotal movement assembly for the cutting head is mounted on the slide or alternatively can be provided on the cutting head itself.

In one embodiment, the slide can be removed from the bearing assembly thus allowing the cutting unit, when provided as a retail package, to have the slide provided and packaged as a separate item thereby allowing the packaging of the cutting unit to have the slide positioned in the most practical position for packaging rather than having to be connected to the base to protrude beyond the base of the cutting unit as is conventionally the case.

In a further embodiment, the slide is detachable from the bearing assembly in use thereby allowing alternative slides to be selectively fitted and used for specific cutting functions as required by the user. Thus, the user may be provided with a cutting unit which receives a range of slides, possibly of different profile, but more typically of different lengths, thereby providing the user with the option of selecting the length of stroke of movement of the cutting head with respect to the base.

Specific embodiments of the invention are now described with reference to the accompanying drawings, wherein:

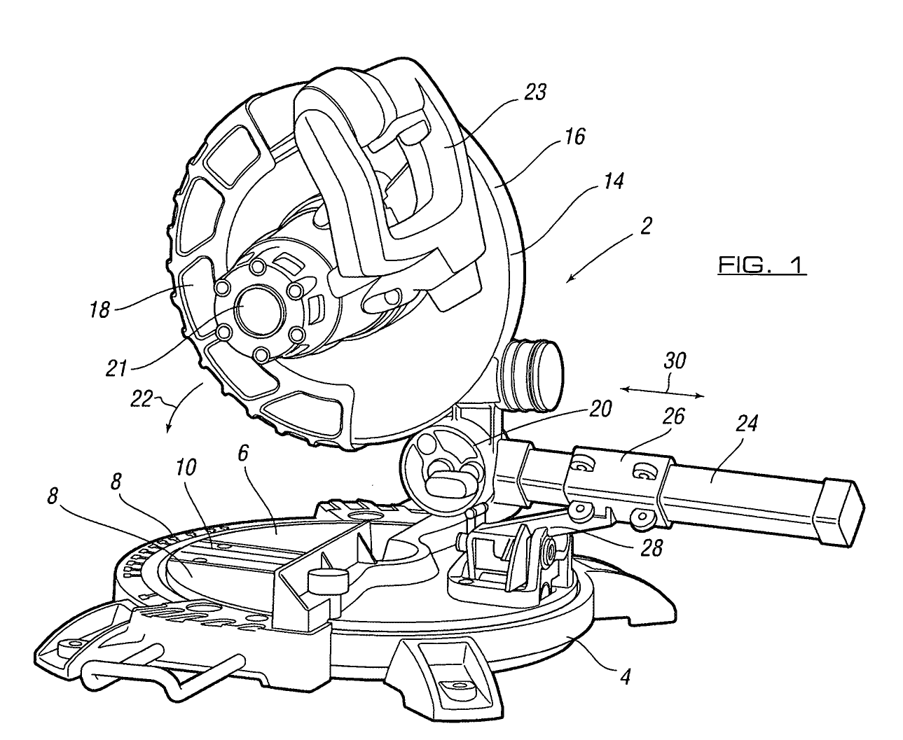

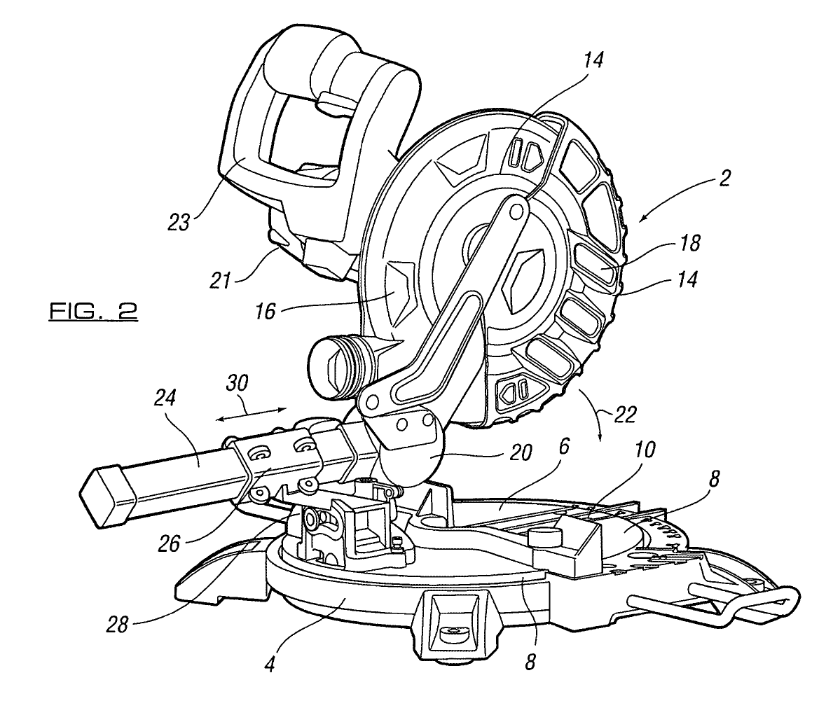

FIGS. 1 and 2 illustrate perspective view of a cutting unit in accordance with the invention in one embodiment; and

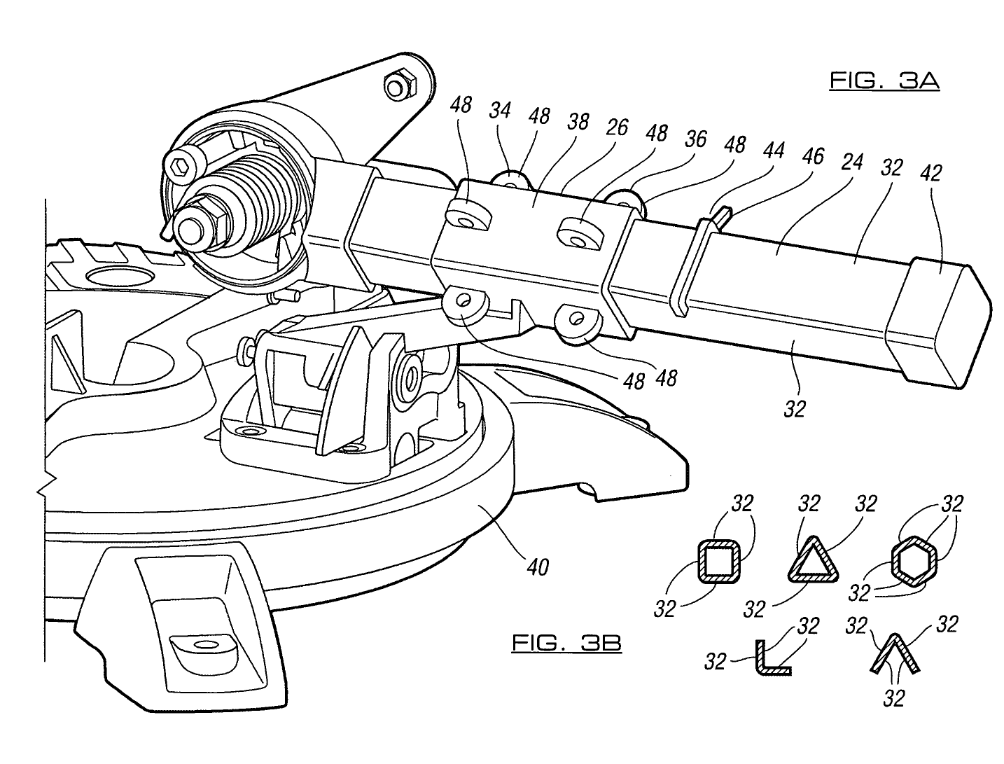

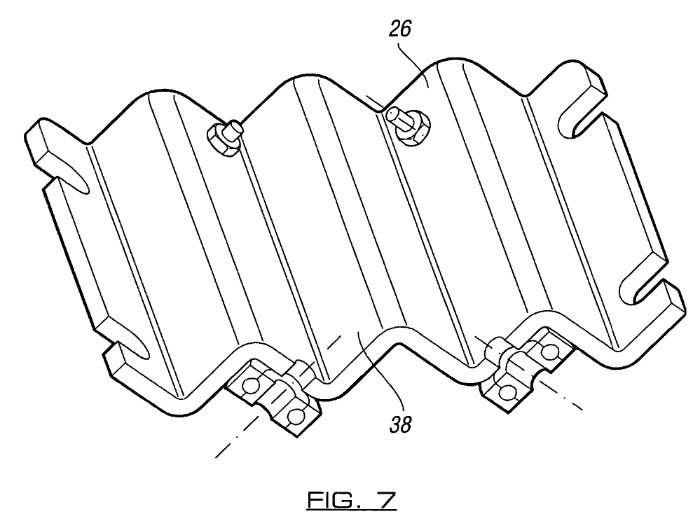

FIGS. 3 to 7 illustrate detailed views of the arrangement between the slide and bearing assembly in accordance with one embodiment of the invention.

Referring firstly to FIGS. 1 and 2, there is illustrated a cutting unit 2. The cutting unit includes a base 4 with a turntable 6. The top faces of the turntable and base form a surface 8 for the reception of a workpiece, not shown, which is to be cut. The base includes a slot 10 for the reception therein of the circular blade (not shown) of a cutting head 14 when the cutting head is moved to the covered cutting position. The cutting head 14 is provided with a guard 16, with a movable portion 18 to expose the blade for cutting.

The cutting head is provided on a pivotal mount 20 so as to be movable between a raised position as shown and the lowered cutting position by movement in direction of arrow 22 at which the lower guard 18, which encloses part of the blade in the raised position, is moved so as to expose the blade and allow the blade to be passed into the workpiece, as the blade is rotated, to perform the cutting operation. The cutting unit can be provided with the provision of a mitre cut and/or a bevel arrangement to allow the same to be angled and/or bevelled and the operation of these will be as with conventional saws of this type.

The cutting head is also provided with a motor 21 for powered rotation of blade and a handle 23. The cutting head is mounted on a slide 24 and in turn, the slide in this embodiment is mounted in a bearing assembly 26 which, in turn, is located on a mounting 28 attached to the base 4. The provision of the slide and bearing assembly allows the cutting head and, in this case, the slide, to be moved as indicated by arrow 30, thereby providing a movement of the cutting head along a horizontal plane in parallel to the surface 8 and hence the workpiece, thereby allowing the blade to be passed along and through the workpiece as the cutting operation takes place. The reverse stroke allows the blade to be returned back to the cutting position.

The slide and bearing assembly is described in more detail in FIGS. 3a to 7. The slide 24 has a profiled cross section such that at least one face 32 is flat along substantially the length of the slide. Preferably, the profile is such that all of the faces of the slide are flat and FIG. 3b illustrates a range of cross sections of various slides which could be used to advantage in the invention and it will be seen that in each case, flat sides 32 are provided.

The particular arrangement of the bearing assembly 26 will be configured to suit the particular profile of slide which is used. Equally any suitable bearing types can be used. In one embodiment the bearing assembly can include at least two spaced sets of bearings 34, 36. The bearings in each set can comprise a roller bearing 48 for each flat surface 32 provided on the slide. With the spacing and length of the bearing housing 38 in general, being selected so as to provide sufficient support for the slide 24 to ensure that the slide is maintained in a substantially horizontal plane regardless of the part of the slide which is located on the bearing assembly at any given time.

Preferably adjustment means are provided (not shown) which allow for the adjustment of the bearings and/or cutting head alignment to allow wear of the slide and/or cutting head to be taken into account.

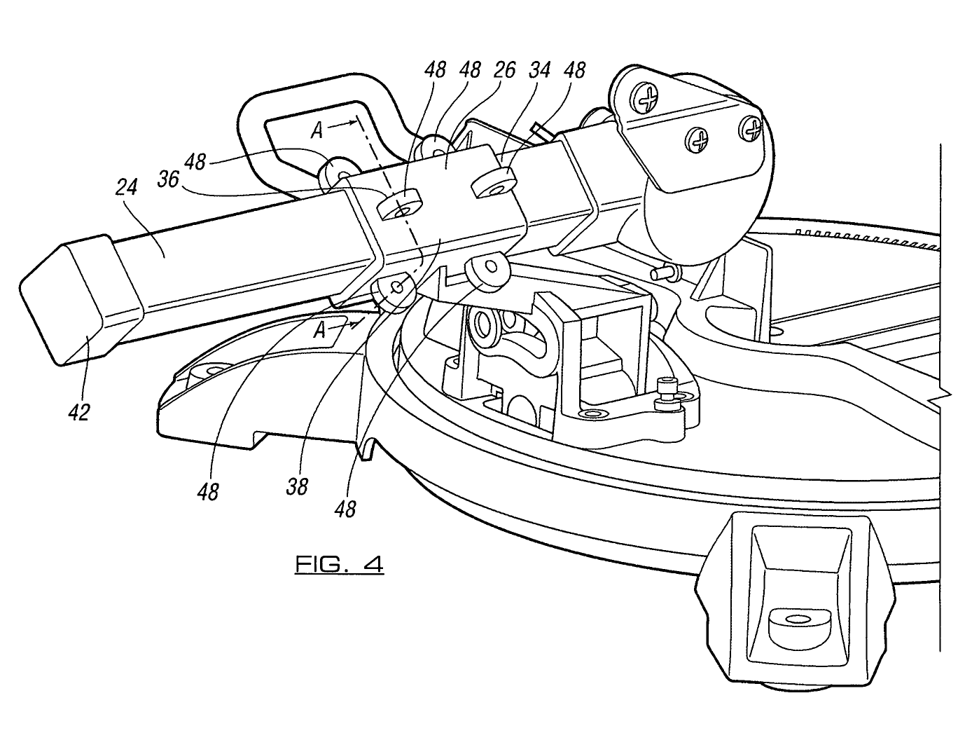

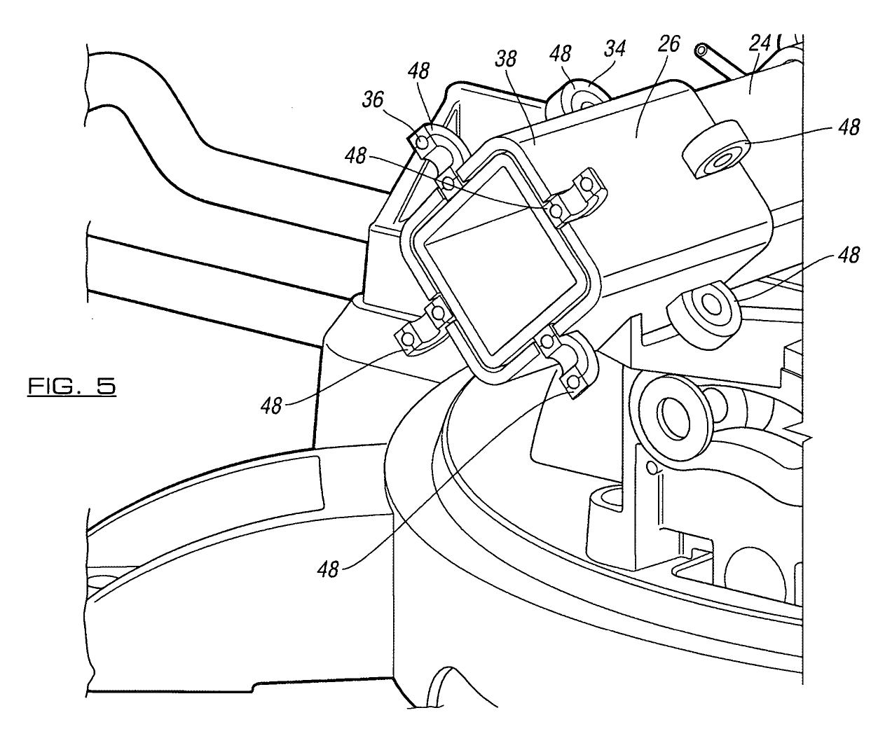

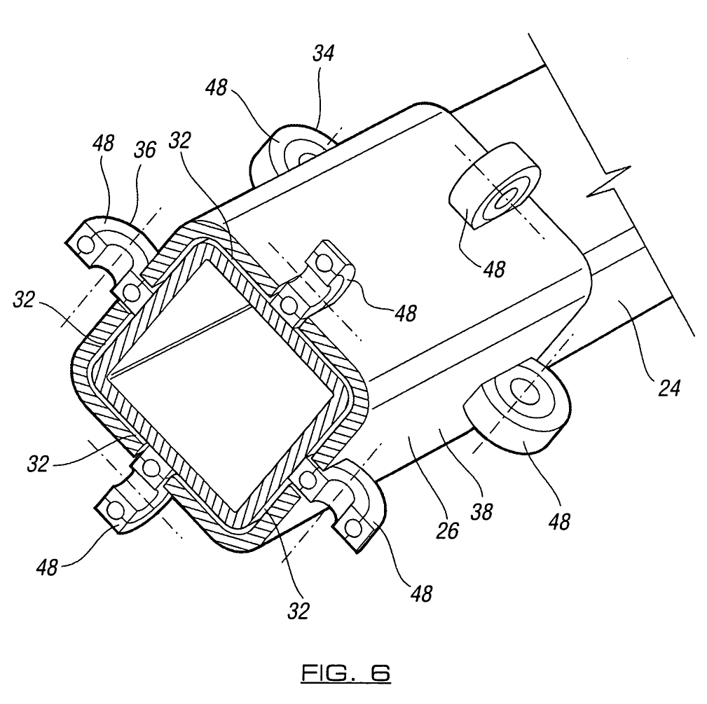

FIGS. 3a and 4 show the bearing assembly positioned intermediate the ends of the slide and FIGS. 5 and 6 illustrate a cross sectional view along line A-A shown in FIG. 4.

Although, in this embodiment, the slide is shown at a position mounted above the base, it should be appreciated that in another embodiment, the slide can be provided to pass through the peripheral wall 40 of the base and/or turntable such that a portion of the slide is held under the top surface 8 of the base and/or turntable.

It will therefore be appreciated that the slide can be selectively removed from the bearing assembly by removing the end cap 42 either for storage purposes and/or packaging purposes. This also allows the substitution of the slide with an alternative slide which may be of a different profile but more typically will be of a different length thereby allowing the required length of stroke to be achieved for particular cutting purposes.

In a further feature of the invention, there may be provided at least one stop member 44 as illustrated in FIG. 3a. The stop member can be selectively positionable along the slide 24 so as to limit the length of stroke of movement of the cutting head. The stop typically is set by the user via a clamp arrangement 46 such as a screw or over centre clamp at a particular location on the slide and retained thereon. This therefore allows a user to determine a particular length of stroke for a particular cutting operation and set the stop or stops so as to define the required length of stroke. Thus, if the cutting operation is to be repeated a number of times, the user can be certain that as long as they move the cutting head to contact the stop or stops, they will have moved the cutting head the required distance for each cut so that the cut will be consistent for each workpiece. This in itself represents an invention which can be used in conjunction with the slides as herein described or can be used with conventional slides and therefore when used in this manner, represents a separate aspect of the current invention. If two stops are provided the distance between the same will define the length of movement of the cutting head on the slide.

The provision of the slide in accordance with the invention offers several advantages. Firstly, as the slide is provided with at least one flat face along the length of the slide, or at least a portion of the slide which defines the extent of movement of the cutting head, so the need for a plurality of slides is removed as the cutting head can be securely axially located on one slide. Furthermore this arrangement lends itself to the ability for the purchaser/user of the cutting unit to self assemble the unit once purchased and subsequently remove and replace the slide in the bearing assembly as required. This allows adaptation of the cutting unit and also more efficient packaging and storage of the slide and hence cutting unit generally.

1. A cutting unit, said cutting unit comprises:
a cutting head having a circular blade provided for rotation and being pivotally movable between a raised position and a lowered, cutting, position and being located on a mounting connected to a base on which a work piece to be cut can be located, said cutting head slidingly movable with respect to the base via at least one slide and wherein said slide is provided, in at least a portion where sliding movement occurs, with at least one elongate, substantially flat face, outer face.

2. Apparatus according to claim 1 wherein a plurality of the external elongate faces of slide have a flat profile.

3. Apparatus according to claim 1 wherein the external shape of the slide in cross section is substantially square.

4. Apparatus according to claim 1 wherein the external shape of the slide in cross section is substantially hexagonal.

5. Apparatus according to claim 1 wherein the external shape of the slide in cross section is substantially triangular.

6. Apparatus according to claim 1 wherein the external shape of the slide in cross section is substantially L-shaped.

7. Apparatus according to claim 1 wherein one slide is provided and the same provides the required location of the cutting head mounting in all axes apart from the longitudinal axis of the slide.

8. Apparatus according to claim 1 wherein a bearing assembly is provided which allows the relative movement of the cutting head with respect to the base.

9. Apparatus according to claim 8 wherein the base or the cutting head is fixed to one end of the slide, and the slide and cutting head move with respect to the base with the movement along the bearing assembly.

10. Apparatus according to claim 8 wherein the slide is fixed at one end to the base and the cutting head moves along the slide with the bearing assembly provided on the cutting head.

11. Apparatus according to claim 8 wherein the portion of the bearing assembly in contact with the slide to move therealong contacts with at least the one elongate flat face on the slide.

12. Apparatus according to claim 1 wherein the pivotal mounting to allow the cutting head to be moved between raised and lowered positions is mounted on the slide.

13. Apparatus according to claim 1 wherein the cutting head is pivotally movable about a pivotal axis substantially parallel with the slide to provide bevel cutting.

14. Apparatus according to claim 1 wherein the slide can be detached from the remainder of the apparatus.

15. Apparatus according to claim 14 wherein any of a range of slides can be selectively fitted to the apparatus.

16. Apparatus according to claim 1 wherein at least one stop is provided on the slide to provide a limit to the extent of movement of the cutting head in at least one direction.

17. Apparatus according to claim 16 wherein the position of the stop on the slide is adjustable by a user of the apparatus.

18. Apparatus according to claim 16 wherein stops are provided, a first to limit movement of the cutting head along the slide in a first direction and the other to limit movement in a second opposing direction.
